(19) United States
(12) Patent Application Publication
(10) Pub. No.: US 2006/0045031 A1
(43) Pub. Date: Mar. 2, 2006

(54) Automatic hardware data link initialization using multiple state machines

(75) Inventors: Mark J. Hickey, Rochester, MN (US); Robert A. Shearer, Rochester, MN (US); Alfred T. Watson III, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/932,728

(22) Filed: Sep. 2, 2004

(51) Int. Cl. H04L 12/16

(52) U.S. Cl. 370/266

(57) ABSTRACT

Methods and apparatuses that may be utilized to automatically train and activate communications links between two or more devices are provided. In some embodiments, one or more state machines may be used to monitor and control the behavior of receive and transmit logic during the automatic training and activation, thus, reducing or eliminating the need for software intervention. As a result, training and activation may begin with little delay after a power-on cycle.

### BACKGROUND OF THE INVENTION

1. Field of the Invention

The present invention generally relates to exchanging packets of data on a bus between two devices and, more particularly to automatically initializing communications interfaces on both devices.

2. Description of the Related Art

A system on a chip (SOC) generally includes one or more integrated processor cores, some type of embedded memory, such as a cache shared between the processors cores, and peripheral interfaces, such as external bus interfaces, on a single chip to form a complete (or nearly complete) system. The external bus interface is often used to pass data in packets over an external bus between these systems and an external device, such as an external memory controller or graphics processing unit (GPU). To increase system performance, the data transfer rates between such devices has been steadily increasing over the years.

Unfortunately, as the data transfer rate between devices increases, bytes of data transferred between devices may become skewed for different reasons, such as internal capacitance, differences in drivers and/or receivers used on the different devices, different routing of internal bus paths, and the like. Such skew may cause data transferred from one device to be read erroneously by the other device. This misalignment can lead to incorrectly assembled data fed into the processor cores, which may have unpredictable results and possibly catastrophic effects.

One approach to minimize this type of skew is to perform some type of training under software control, whereby internal drivers and/or receivers of one device may be adjusted while the other device outputs specially designed data packets (e.g., having known data patterns). Unfortunately, there may be substantial delay (e.g., after a system power-on cycle) before such software code can be executed. Further, performing such training in software may undesirably delay or interrupt the execution of actual application code.

Accordingly, what is needed are methods and apparatus for automatically training and activating communications links between devices, preferably with little or no software intervention.

### SUMMARY OF THE INVENTION

The present invention generally provides methods and apparatus for automatically training and activating communications links between two or more devices.

One embodiment provides a method of training a local device for communication with a remote device over a communications link without software intervention. The method generally includes, under hardware control, performing receive link training to adjust receive link components on the local device, wherein successful receive link training is determined on the basis of a history of comparisons of checksums calculated for packets received from the remote device, providing an indication of whether the local device receive link components have been successfully trained in packets transmitted from the local device to the remote device, performing transmit link training during which predefined synchronization packets are transmitted to the remote device for use in adjusting receive link components on the remote device, and monitoring packets received from the remote device for an indication the remote device receive link components have been successfully trained.

Another embodiment provides a method of training two devices for communication over a link without software interaction. The method generally includes performing hardware controlled transmit link training in each device, wherein synchronization packets are transmitted to the other device, performing initial hardware controlled receive link training in each device to compensate for skew between bits of data transmitted over the link and achieve synchronization with the other device based on synchronization packets received from the other device, and performing hardware controlled handshaking between the devices to indicate successful link training, wherein the hardware controlled handshaking comprises, for each device, providing an indication in a control packet sent to the other device that the device sending the control packet has achieved synchronization.

Another embodiment provides a self-initializing bus interface for use in communicating between a first device containing the bus interface and a second device over a communications link. The bus interface generally includes a receive state machine and a transmit state machine. The receive state machine is generally configured to manage receive link training, wherein the receive state machine is configured to maintain a history of comparisons of checksums calculated for packets received from the second device and provide, in control packets transmitted to the second device, an indication receive link training is successful if a predetermined number of successive successful checksum comparisons is observed. The transmit state machine is generally configured to manage transmit link training, wherein the transmit state machine is configured to transmit a stream of synchronization packets to the second device with control packets containing checksums interspersed with the synchronization packets for use in performing checksum comparisons by the second device.

Another embodiment provides a system, generally including a bus having a plurality of parallel bit lines, a first processing device, and a second processing device coupled with the first processing device via the bus. A self-initializing bus interface on each of the first and second processing devices is generally configured to perform, without software interaction, transmit link training wherein synchronization packets are transmitted to the other device, receive link training to compensate for skew between bits of data transmitted over the link and achieve synchronization with the other device based on synchronization packets received from the other device, and handshaking between the devices to indicate successful link training by providing an indication in a control packet sent to the other device that the device sending the control packet has achieved synchronization.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system including a central processing unit (CPU), in which embodiments of the present invention may be utilized.

FIG. 2 is a block diagram of a communications interface according to one embodiment of the present invention.

FIG. 3 is a state diagram corresponding to a link training state machine, according to one embodiment of the present invention.

FIG. 4 is a flow diagram of exemplary operations for automatic link training, according to one embodiment of the present invention.

FIG. 5 is a diagram of exemplary operations for automatic link training performed at local and remote devices, according to one embodiment of the present invention.

FIG. 6 is a block diagram of a communications interface according to one embodiment of the present invention.

FIG. 7 is a state diagram corresponding to a communications link receive state machine, according to one embodiment of the present invention.

FIGS. 8A and 8B are block diagrams of a communications interface during receive link training according to one embodiment of the present invention.

FIG. 9 is a state diagram corresponding to a communications link transmit state machine, according to one embodiment of the present invention.

FIGS. 10A and 10B are block diagrams of a communications interface during transmit link training according to one embodiment of the present invention.

FIG. 11 is a state diagram corresponding to generation of a debounced reset signal according to one embodiment of the present invention.

### DETAILED DESCRIPTION OF THE INVENTION

The principles of the present invention provide for methods and apparatuses that may be utilized to automatically train and activate communications links between two or more devices. In some embodiments, one or more state machines may be used to monitor and control the behavior of receive and transmit logic during the automatic training and activation, thus, reducing or eliminating the need for software intervention. As a result, training and activation may begin with little delay after a power-on cycle.

As used herein, the term state machine generally refers to an object in a system that goes through a defined sequence of states in response to various events, with each state often indicated by a specific observable action, such as the generation of a signal. Embodiments of the present invention will be described with reference to state machines implemented as hardware components that respond to various events, typically with the generation of one or more signals used to control the behavior of some other component. However, various behaviors of the state machines may be determined by software-controlled registers, such as registers used to hold adjustable threshold counter values or time-out periods.

Further, in the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

### An Exemplary System

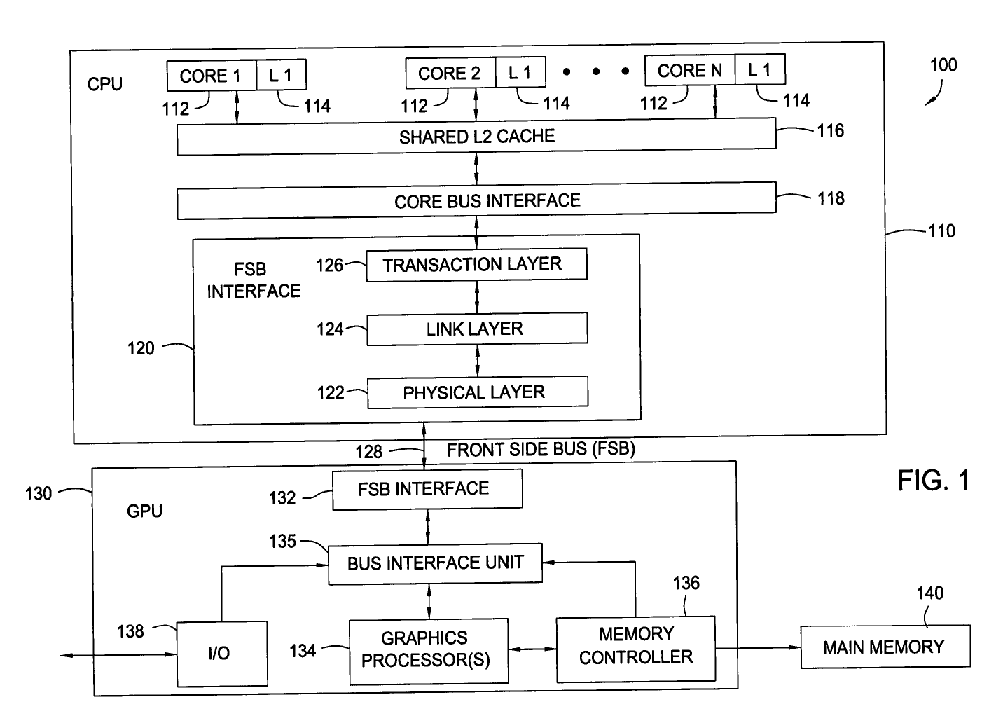

FIG. 1 illustrates an exemplary computer system 100 including a central processing unit (CPU) 110, in which embodiments of the present invention may be utilized. As illustrated, the CPU 110 may include one or more processor cores 112, which may each include any number of different type function units including, but not limited to arithmetic logic units (ALUs), floating point units (FPUs), and single instruction multiple data (SIMD) units. Examples of CPUs utilizing multiple processor cores include the Power PC line of CPUs, available from International Business Machines (IBM).

As illustrated, each processor core 112 may have access to its own primary (L1) cache 114, as well as a larger shared secondary (L2) cache 116. In general, copies of data utilized by the processor cores 112 may be stored locally in the L2 cache 116, preventing or reducing the number of relatively slower accesses to external main memory 140. Similarly, data utilized often by a processor core may be stored in its L1 cache 114, preventing or reducing the number of relatively slower accesses to the L2 cache 116.

The CPU 110 may communicate with external devices, such as a graphics processing unit (GPU) 130 and/or a memory controller 136 via a system or frontside bus (FSB) 128. The CPU 110 may include an FSB interface 120 to pass data between the external devices and the processing cores 112 (through the L2 cache) via the FSB 128. An FSB interface 132 on the GPU 130 may have similar components as the FSB interface 120, configured to exchange data with one or more graphics processors 134, input output (I/O) unit 138, and the memory controller 136 (illustratively shown as integrated with the GPU 130).

As illustrated, the FSB interface 120 may include a physical layer 122, link layer 124, and transaction layer 126. The physical layer 122 may include hardware components for implementing the hardware protocol necessary for receiving and sending data over the FSB 128. The physical layer 122 may exchange data with the link layer 124 which may format data received from or to be sent to the transaction layer 126. The transaction layer 126 may exchange data with the processor cores 112 via a core bus interface (CBI) 118. For some embodiments, data may be sent over the FSB as packets. Therefore, the link layer 124 may contain circuitry (not shown) configured to encode into packets or “packetize” data received from the transaction layer 126 and to decode packets of data received from the physical layer 122.

### Automatic Link Initialization

As previously described, bytes of data transferred over the FSB 128 between the CPU 110 and GPU 130 (or any other type of high speed interface between devices) may become skewed due to various factors, such as internal capacitance, differences in internal components (e.g., drivers and receivers), different routing of the internal data paths, thermal drift, and the like. In order to compensate for such skew, both devices may utilize some type of mechanism (e.g., the mechanisms may work together) to automatically train and activate the communications links. The architecture described herein may be utilized to achieve and maintain synchronization between both sides of the link (also referred to herein as link training), including a handshaking protocol where each device can indicate to the other it is synchronized.

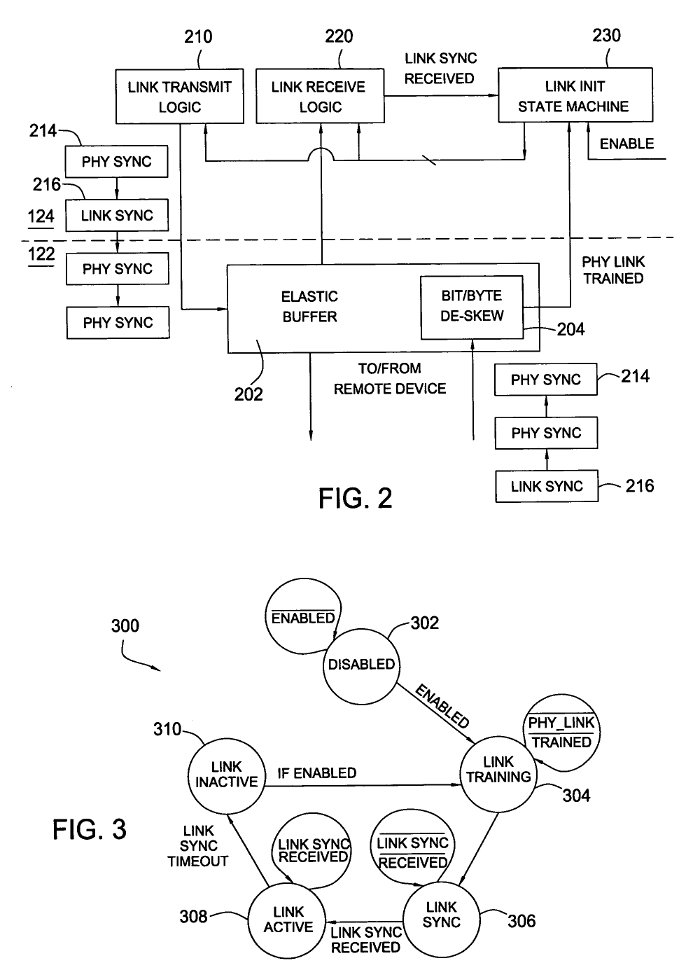

For example, as illustrated in FIG. 2, the link layer 124 may include one or more state machines 230 generally configured to monitor the local physical layer 122, as well as a physical layer of the remote device with which the local device communicating (e.g., a physical layer in the FSB interface 132 of the GPU 130). While only one side of a communications link is shown (the CPU 120 side), it should be understood that similar operations may be performed on the other side of the link (e.g., the GPU 130 side). As illustrated, the state machine 230 may also monitor and control link transmit and receive logic 210 and 220, respectively, in the link layer 124, as well as an elastic buffer 202 used to hold data transferred to and from the link layer 124. In general, the term elastic buffer refers to a buffer that has an adjustable size and/or delay to hold varying amounts of data for varying amounts of time, depending on how rapidly the link layer is able to fill or unload data.

As illustrated, a bit de-skew component 204 may be provided to compensate for skew between bits of data received. Proper bit alignment may be achieved, for example, by multiplexing various time-delayed versions of bit signals to eliminate skew. For some embodiments, the bit de-skew component 204 may automatically adjust each bit to achieve proper alignment while packets of known data, referred to herein as a physical synchronization (Phy-Sync) packets 214 are transmitted by the device at the other end of the link. Physical synchronization may also involves aligning each individual data bit to a clock signal transmitted with the data using analog phase detection circuitry. In other words, signals on individual bit lines may, in effect, be delayed in order to properly align them with one or more bit signals that lag behind them. These adjustments may be made to various bit signals until the resulting bytes match the known patterns transmitted in the Phy-Sync packets. For some embodiments, in one or more states, the state machine 230 may generate one or more signals causing the link transmit logic 210 to transmit a stream of Phy-Sync packets, allowing similar adjustments to the physical layer of the remote device.

### Exemplary Link Initialization States

FIG. 3 is a state diagram 300 illustrating the various states of the state machine 230, in accordance with one embodiment of the present invention. As illustrated, the state machine 230 may begin in a Disabled state 302 until an ENABLED signal is asserted. While not shown, it should be noted that each state shown (Link Training 304, Link Sync 306, Link Active 308, and Link Inactive 310) may also transition directly to the Disabled state if the ENABLED signal is de-asserted. It should also be noted that, for some embodiments, the link may be assumed to be in operation all the time and the Disabled state 302 may be removed. For embodiments with a Disabled state, the FSB interface 120 may remain in this state in the absence of a stable (e.g., debounced for some period of time) power signal or when the ENABLED signal is de-asserted under program control (e.g., via a control register accessible by program code). As illustrated, when enabled, the link may transition from the Disabled state 302 to a Link Training state 304.

In the Link Training state 304, the hardware (drivers and receivers) of the physical layer 122 may be adjusted to match those of the remote device at the other end of the link (e.g., adjusting for proper bit and byte de-skew). Upon entering this state, the link transmit logic 210 begins to transmit a continuous stream of Phy-Sync packets 214, enabling training of the remote device hardware. The link receive logic 220 is also enabled and begins a training process looking for Phy-Sync packets received from the remote device. The physical layer 122 may remain in this state while no Phy-Sync packets 214 are received from the remote device and may transition back to the Disabled state if the ENABLED signal is disabled.

For some embodiments, a transition from the Link Training state 304 to the Link Sync state 306 occurs when the remote device begins transmitting Phy-Sync packets (indicating the remote device has also entered the Link Training state) and when the receiver hardware of the physical link 122 of the local device is successfully trained. For some embodiments, the physical layer hardware may indicate successful training by asserting a PHY_LINK_TRAINED signal, for example, when de-skew logic 204 has been properly adjusted for bit alignment resulting in detection of Phy-Sync packets. Alternatively, link receive logic 220 may determine training has been successful when some predetermined number of Phy-Sync packets have been received and counted.

In the Link Sync state 306, the link transmit logic 210 may transmit a Synchronization sequence (Sync sequence) including some number (M) of Phy-Sync packets followed by a different type of packet having a known data pattern (shown as a Link-Sync packet 216 in FIG. 2). For some embodiments, the Phy-Sync and Link-Sync packets may differ only by some small number of bit values. In any case, the transmission of a Link-Sync packet indicates to the remote device that the local device is trained. Similarly, receipt of a Link-Sync packet from the remote device indicates the remote device is trained. For some embodiments, the link receive logic 220 may indicate receipt of a Link-Sync packet by asserting a LINK_SYNC_RECEIVED signal, causing a transmission to the Link Active state 308.

The Link Active state 308 indicates the physical and link layers 122 and 124 of both sides of the link have performed the necessary handshaking to validate they can transfer information between each other. Thus, in this state, packets may be transferred between the local and remote devices at will. Due to variations in time with drivers, receivers, and wiring caused by environmental factors, the local and remote devices may be at risk of falling out of synch (due to bit skew). Therefore, in order to maintain synchronization and stay in the Link Active state 308, each device on the link may be required to periodically transmit a Sync sequence (M Phy-Sync packets followed by a Link-Sync packet), allowing periodic adjustments of link hardware. For some embodiments, if a periodic Sync sequence is not received within some timeout period (e.g., an adjustable Link Sync timeout period), retraining of the link may be initiated.

For example, if a Sync sequence is not received within the predetermined Link Sync timeout period, a transition to a Link Inactive state may occur. From the Link Inactive sate 310, a transition back to the Link Training state 304 may occur, if the ENABLED signal is still asserted, otherwise a transition back to the Disabled state 302 may occur. The Link Inactive state 310 is optional and may be removed for some embodiments.

### Exemplary Link Training Operations

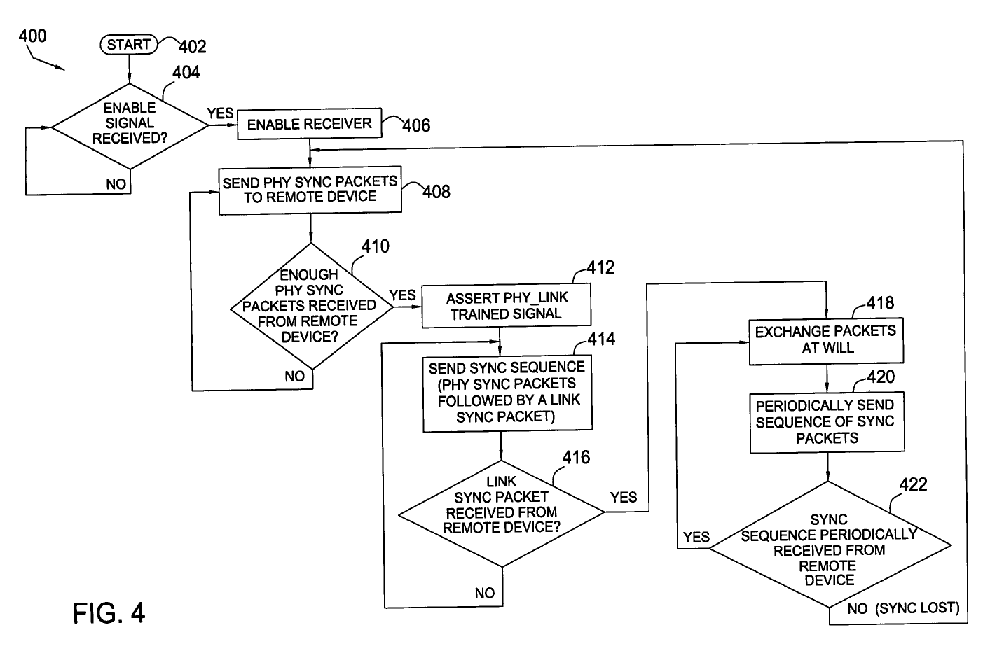

FIG. 4 is a flow diagram illustrating exemplary operations 400 performed at the local device with respect to each state shown in FIG. 3. The operations 400 begin at step 402, for example, upon system power-up, entering the Disabled state 302. The device remains in the Disabled state 302 until the ENABLED signal is asserted, at step 404. Once the ENABLED signal is asserted, the device transitions to the Link Training state 304, and enables the link receive logic, at step 406. At step 408, the link transmit logic 408 begins to send Phy-Sync packets to the remote device, until a Phy-Sync packet is received from the remote device.

Once a Phy-Sync packet is received, the PHY_LINK_TRAINED signal may be asserted at step 412, causing a transition to the Link Sync state 306. At step 414, a Sync Sequence (Phy-Sync packets followed by a Link-Sync packet) is transmitted to the remote device, providing an indication the local device is trained. The local device remains in the Link Sync state 306 until a Link-Sync packet is received from the remote device, at step 416, indicating the remote device is also trained. Once the Link-Sync packet is received from the remote device, the local device may transition to the Link Active state 308 and packets may exchanged at will, at step 418. As illustrated, the local device may periodically send Sync Sequences to the remote device, at step 420. If a Sync Sequence is not periodically received from the remote device, at step 422, the local device will initiate retraining, for example, transitioning back to the Link Training state 304.

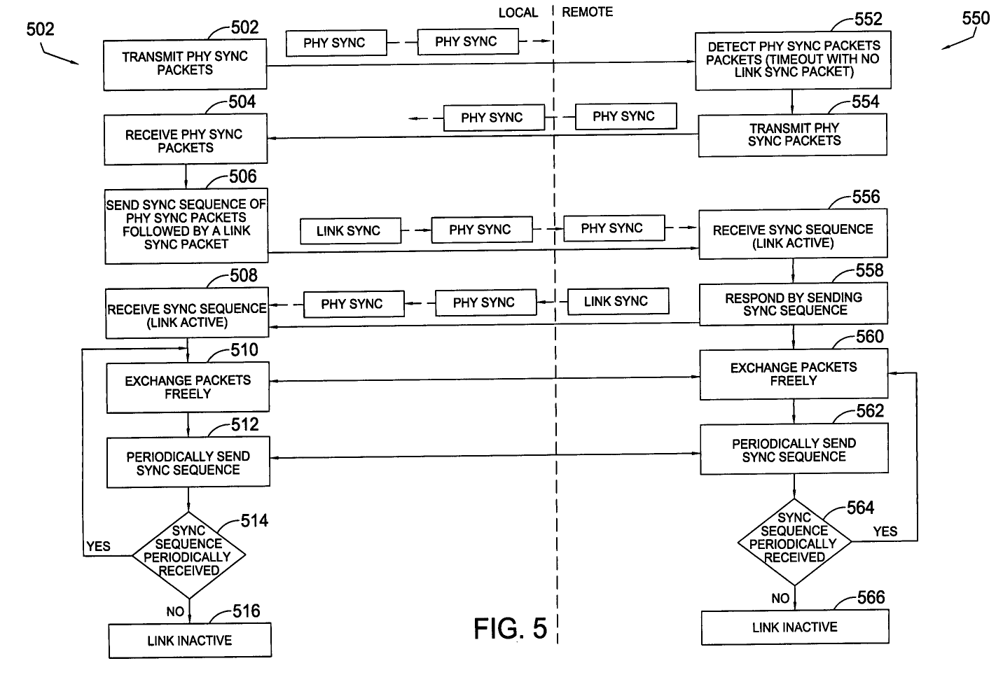

FIG. 5 illustrates link training operations 550 that will be performed on the remote device while corresponding operations 500 are performed on the local device. While FIG. 5 illustratively shows link training being initiated by the local device, it should be understood that either end of the link may actually initiate training independently upon system power up and that which device (e.g., a CPU or GPU) is considered a local device and which is considered a remote device is somewhat arbitrary.

In any case, the operations 500 begin by transmitting Phy-Sync packets from the local device to the remote device. At step 552, the Phy-Sync packets are detected at the remote device, which begins transmitting Phy-Sync packets. At step 504, Phy-Sync packets are received at the local device which, in response, transmits a Sync sequence to the remote device. At step 556, the remote device receives the Sync sequence, causing a transition to the Link Active state. The remote device may respond by sending a Sync Sequence back to the local device, at step 558. At step 508, the local device receives the Sync sequence, causing a transition to the Link Active state. With both devices in the Link Active state, they may exchange packets freely, at steps 510 and 560. As illustrated, to maintain synchronization, each device may periodically send Sync sequences, at steps 512 and 562. If either device fails to receive a Sync sequence within a predetermined period, at steps 514 or 564, that device may transition to the Link Inactive state, at step 516 or 566 (from which link re-training may be initiated).

### Automatic Link Training with Multiple State Machines

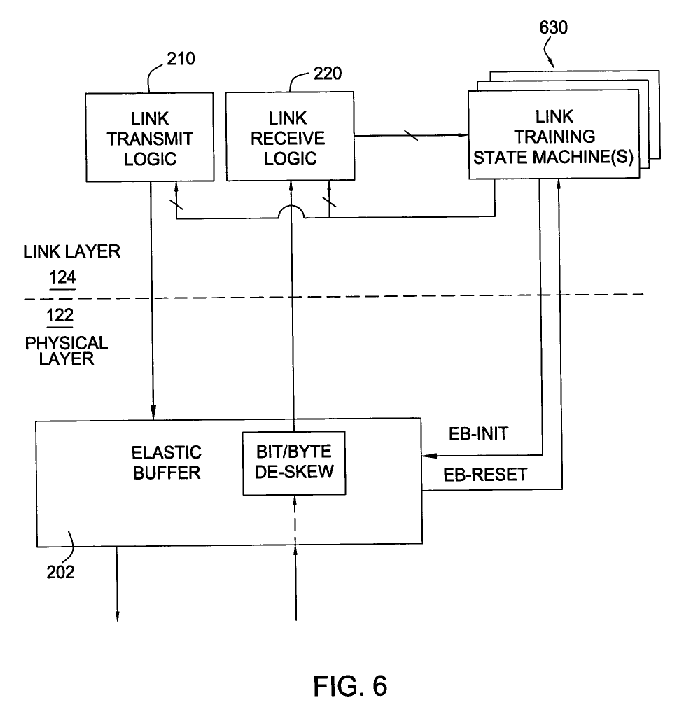

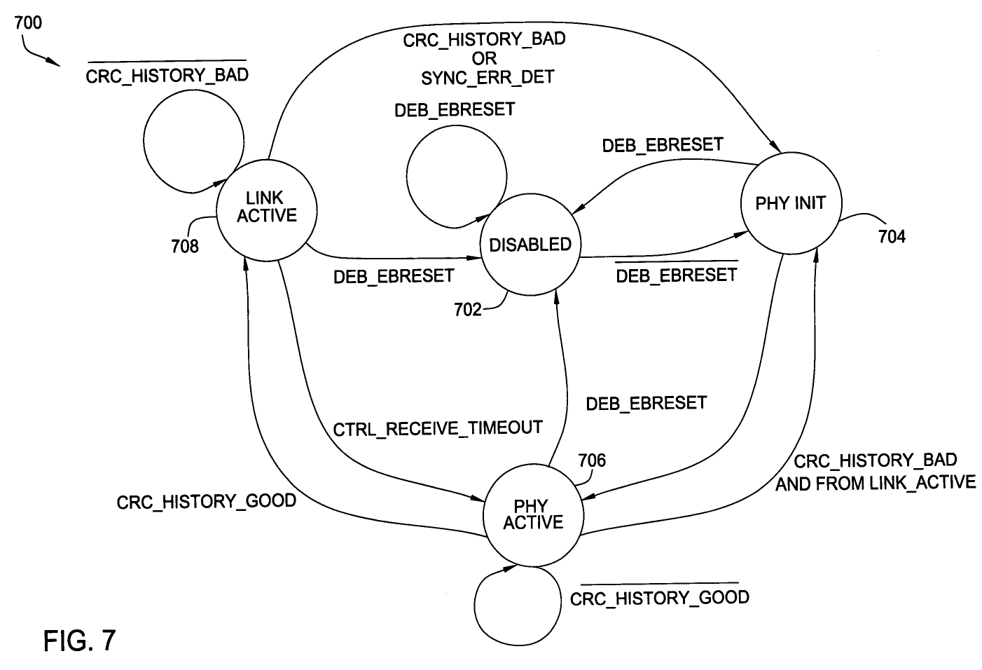

As illustrated in FIG. 6, for some embodiments, multiple state machines 630 may be used to monitor and control receive training, transmit training, and reset states, in a modular manner. As will be described below with reference to the following FIGS. 7-11, the state machines 630 may include a Receive Active state machine 632, a Transmit Initialize state machine 634, and an Elastic Buffer (EB) reset state machine 636, which each provide different functionality.

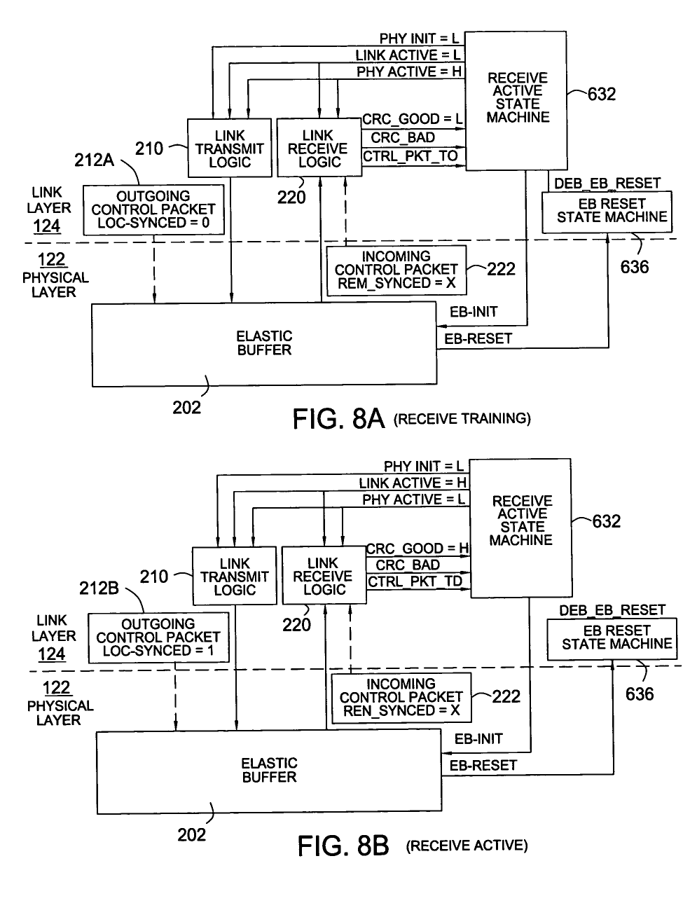

FIG. 7 is a state diagram 700 illustrating various states of the Receive Active state machine 632, shown in FIGS. 8A and 8B, that monitors and controls receive training. Operation of the Receive Active state machine (RASM) 632 may be described with simultaneous reference to FIGS. 7, 8A, and 8B.

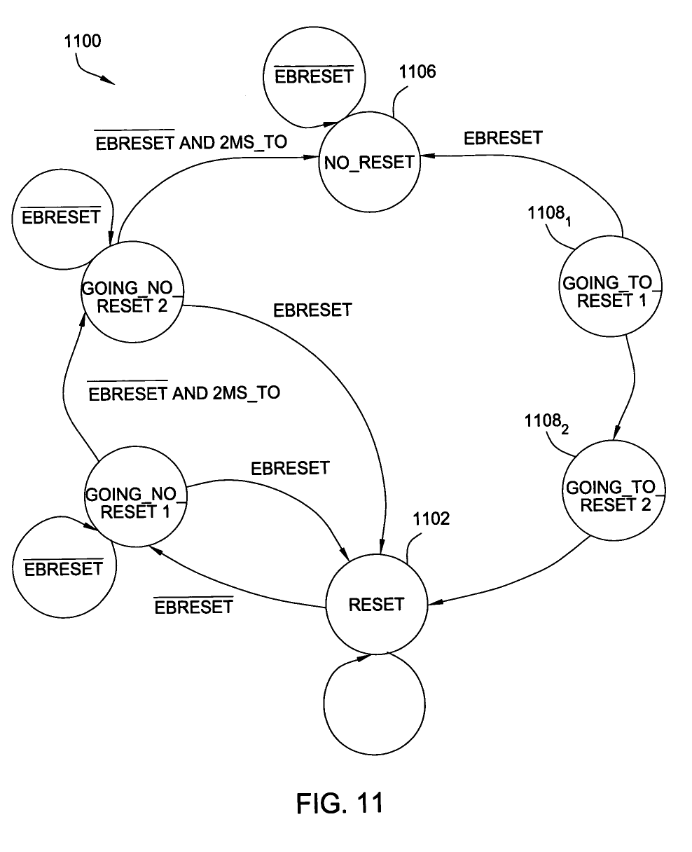

As illustrated in FIG. 7, the RASM 632 may stay in a Disabled state 702, as long as a debounced reset signal (deb_ebreset) is asserted. For some embodiments, the elastic buffer 202 may perform a clock detect on an incoming clock signal (generated by the remote device) and, in response, generate a signal indicating the elastic buffer 202 is coming out of a reset condition. In other words, this reset signal (ebreset) may be used by the link layer 124 as notification that the device on the other end of the communications link (e.g., FSB) is powered up and driving the link. As will be described in greater detail below, with reference to FIG. 11, an elastic buffer reset state machine (EBRSM) 636 may be configured to debounce this reset signal (ebreset) and generate the debounced reset signal (deb_ebreset).

Illustratively, the ebreset and deb_ebreset signals indicate a reset condition when held high (no clock detected) and an active condition when held low (clock detected). In order to provide a stable reset signal, the EBRSM 636 may only change the state of the deb_ebreset signal if the state of the ebreset is stable (held low or high with no transitions) for a predetermined period of time. For example, if ebreset is seen low for some period of time (e.g., 2-4 ms), the EBRSM 636 may assert the deb_ebreset signal (low), causing a transition from the Disabled state 702 to a Physical Layer Initialize (PhyInit) state 704, as shown in FIG. 7. In the PhyInit state 704, the RASM 632 may activate an initialization signal (EBInit) to initialize the elastic buffer 202, after which the RASM 632 may transition to a Physical Layer Active (PhyActive) state 706.

As illustrated in FIG. 8A, while in the PhyActive state 706, the RASM 632 may assert a phy_active signal to the Link Receive and Transmit logic 210 and 220. The phy_active signal may indicate to the Link Receive logic 220 that it may begin receive training by monitoring for incoming control packets 222. The phy_active signal may also indicate to the Transmit Receive logic 210 that the receive link is being trained and that a LOCAL_SYNCED bit in all outgoing control packets 212_{A} should be de-asserted (LOCAL_SYNCED=0), signaling the link logic on the other device that it should start sending Phy Sync packets. Incoming control packets 222 may have a similar bit (REMOTE_SYNCED) indicative of whether the receive link of the remote device is being trained.

The link receive logic 220 may calculate checksums on incoming control packets 222 and compare the calculated checksums to checksums sent with the control packets 222. In other words, the incoming control packets 222 may contain checksums generated at the remote device prior to transmission. As used herein, the term checksum generally refers to any type of error correction code calculated on the basis of the contents of a data packet, and may be calculated using any suitable algorithm, such as a simple sum of bytes, a cyclic redundancy check (CRC) algorithm, or some type of hash function. For some embodiments, the link receive logic 220 may maintain a history of these checksum comparisons, for example, as a bit string with each bit indicating whether a checksum comparison for a string of successive control packets failed or succeeded (e.g., with a bit cleared to indicate a failure or set to indicate a success). The link receive logic 220 may then generate one or more control signals indicative of the recent checksum history (e.g., whether the most recent N checksum comparisons were successful or failed).

For example, the link receive logic 220 may assert a CRC_HISTORY_GOOD signal indicating some number of successive packets have been received with good checksums (e.g., CRC history=b‘11111111’) or assert a CRC_HISTORY_BAD signal indicating some number of successive packets have been received with a bad checksum (e.g., CRC history=b‘00000000’). For some embodiments, the number of control packets monitored may be adjustable, for example, in software by writing to a control register. As illustrated in FIG. 7, when the CRC_HISTORY_GOOD signal is asserted, indicating successful receive link training, the RASM 632 may transition to a Link Active state 708.

As illustrated in FIG. 8B, while in the Link Active state, the RASM 632 may assert a link_active signal to the receive logic 220 (indicating successful receive link training) and that it should receive all packets. The link_active signal may also be asserted to the transmit logic 210, indicating the LOCAL_SYNCED bit in all outgoing control packets 222B should be asserted (LOCAL_SYNCED=1) to indicate to the link logic on the remote device that it can stop transmitting Phy Sync packets.

For some embodiments, when individual CRC errors occur (e.g., resulting in CRC_history !=b‘11111111’) the CRC_HISTORY_GOOD signal may be de-asserted and the link receive logic 220 may temporarily halt the processing of incoming request and response traffic. It should be noted however that, in the illustrative state diagram 700, deactivation of the CRC_HISTORY_GOOD signal alone does not cause a state transition from the LinkActive state 708. Rather, a transition from the LinkActive state 708 may not occur until a number of successive packets with bad CRCs have been received, for example, as evidenced by assertion of the CRC_HISTORY_BAD signal (e.g., indicating CRC history=“0000000”). If the CRC_HISTORY_BAD signal is asserted by the link receive logic 220 while in the Link Active state 708 (or some other type of synchronization error is detected as indicated by a sync_err_det signal), the RASM 632 may transition (back) to the PhyInit state 704. If the CRC_HISTORY_BAD signal is asserted by the link receive logic 220 while in the Phy Active state 706 (after having transitioned from the Link Active state 708 due to a receive packet timeout), the RASM 632 may also transition (back) to the PhyInit state 704. In the PhynInit state 704, the RASM 632 may signal the link transmit logic 210 to send a pair of Phy Sync packets and a control packet with the LOCAL_SYNCED bit deactivated, indicating the remote device should again transmit PhySync packets. The RASM 632 may then again transition to the Phy Active state 706, and proceed as described above.

As shown in the state diagram 700, if the deb_ebreset signal is activated at any time, the RASM 632 may transition back to the Disabled state. Further, for some embodiments, the incoming flow of packets may be monitored for control packets based on a predetermined (and possibly adjustable) Control Packet Timeout Register. If a control packet is not received in the Timeout period specified by this register, the RASM 632 may transition back to the Phy Active state, similar to the functionality described above with reference to the Link Sync Timeout shown in FIG. 3.

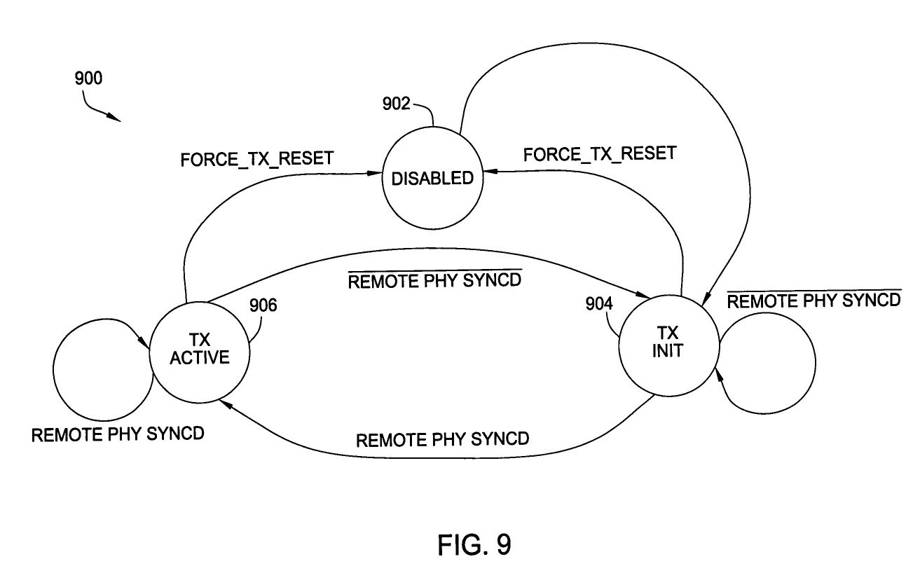

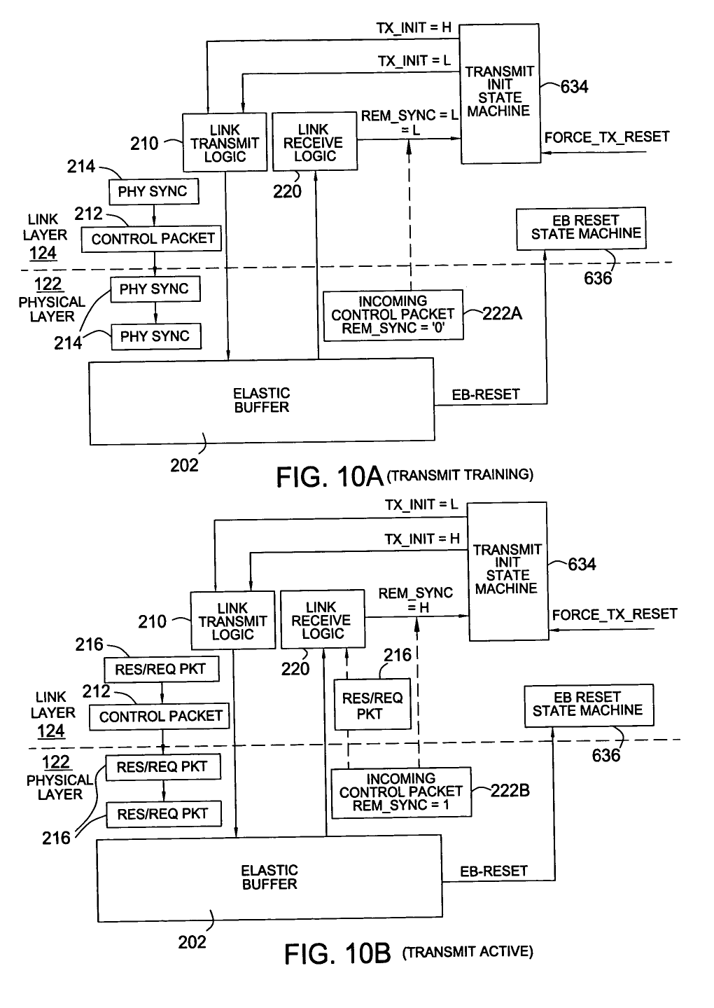

FIG. 9 is a state diagram 900 illustrating various states of the Transmit Init state machine (TISM) 634. As illustrated in FIGS. 10A and 10B, this state machine may be configured to manage and control operations during the physical layer initialization sequence. Operation of the TISM 634 may be described with simultaneous reference to FIGS. 9, 10A, and 10B.

As shown in FIG. 9, the TISM 634 may transition (e.g., on power up or under software control) from the Disabled state 902 to a Transmit Initialization (TxInit) state 904. As illustrated in FIG. 10A, in the TxInit state 904, the TISM may assert a Tx_Init signal, causing the Link Transmit logic 210 to flood the communications link with Phy Sync packets 214. As previously described, these Phy Sync packets 214 serve to synchronize the remote device hardware (e.g., receivers and elastic buffers), and may be transmitted as long as the REMOTE_SYNCED bit in incoming control packets 222_{A} is clear. As illustrated, control packets 212 may be interspersed with these Phy Sync packets, for example, based on the previously described Control Packet Timeout Register. These control packets may be used by the link layer receive logic on the remote device to detect a series of packets with good CRC as an indication that the physical layer thereon is synchronized and available for traffic.

As illustrated in FIGS. 9 and 10B, when the incoming control packets 222B indicate that the remote device has synchronized its receiver and needs no more Phy-Sync packets (by setting the REMOTE_SYNCED bit), the TISM 634 may transition to a Transmit Active (TxActive) state 906. While in the TxActive state the link is enabled for all traffic transmission, allowing free exchange of response/request data packets 216 between the local and remote devices. As illustrated in FIG. 9, if the receive link layer logic 220 indicates that it has detected an incoming control packet 222 with the REMOTE_SYNCED bit deactivated (indicating that the remote chip has lost sync), the TISM 634 may transition back to the TxInit state 904, to repeat training, thus allowing automatic recovery of synchronization with the remote device. As illustrated, for some embodiments, after being disabled the TISM may be forced into a disabled state under a software control (force_tx_reset), from the TxActive and TxInit states.

FIG. 11 is a state diagram 1100 illustrating various states of the Elastic Buffer reset state machine (EBRSM) 636, utilized to provide a stable, debounced reset signal (deb_ebreset) to the Receive Active and Transmit Init state machines 632 and 634. The EBRSM 636 may validate the transition of the ebreset signal (asserted by the elastic buffer 202 in response to detecting a clock signal) from the physical layer 122 by verifying that the ebreset signal is stable (not changing) for some predetermined time period (illustratively, 2 ms to 4 ms) before passing the validated reset signal (deb_ebreset) to the transmit and receive state machines. As illustrated, the EBRSM 636 has two main states, an EBReset state 1102, during which the deb_ebreset signal is de-asserted (held high), indicating the Elastic Buffer is in a reset condition (no clock signal detected), and a No_Reset state 1106, during which the deb_ebreset signal is asserted (held low), indicating the remote device is driving the link (clock signal detected).

As illustrated, a high to low transition of the ebreset signal may cause a transition from the EBReset state 1102 to a first intermediate No_Reset state 1104₁. In order to debounce the signal from 2-4 ms, a transition to a second intermediate No_Reset state 1104₂ may only occur if the ebreset signal stays remains low for 2 ms, otherwise a transition back to the EbReset state 1102 will occur. Similarly, a transition to the No_Reset state 1106 (causing deb_ebreset to be brought low) from the second intermediate No_Reset state 1104₂ may only occur if the ebreset signal remains low for another 2 ms. A transition back to the EbReset state 1102 from the No_Reset state 1106 may similarly utilize first and second intermediate EBReset states 1108₁ and 1108₂ in order to ensure the ebreset signal is high for 2-4 ms before changing the state of the deb_ebreset signal to high, forcing the receive and transmit state machines 632 and 634 back to their Disabled states.

### CONCLUSION

By performing specially designed operations in hardware, components used to communicate between two or more devices over a communications link may be automatically trained with no software interaction required. Accordingly, the devices may begin link training immediately at power up which may result in availability of the link, fully trained, by the time it is needed by software. By utilizing multiple state machines, receive and transmit link training operations may be separated in a modular manner, possibly simplifying training operations. This approach not only simplifies link training, but may provide a robust and efficient system where the training can be done only on those areas that need it.

While the foregoing is directed to embodiments of the present invention, other and further embodiments of the invention may be devised without departing from the basic scope thereof, and the scope thereof is determined by the claims that follow.

What is claimed is:

1. A method of training a local device for communication with a remote device over a communications link without software intervention, comprising, under hardware control:
performing receive link training to adjust receive link components on the local device, wherein successful receive link training is determined on the basis of a history of comparisons of checksums calculated for packets received from the remote device;
providing an indication of whether the local device receive link components have been successfully trained in packets transmitted from the local device to the remote device;
performing transmit link training during which predefined synchronization packets are transmitted to the remote device for use in adjusting receive link components on the remote device; and
monitoring packets received from the remote device for an indication the remote device receive link components have been successfully trained.

2. The method of claim 1, wherein the transmit link training is terminated in response to detecting the remote device receive link components have been successfully trained.

3. The method of claim 1, wherein monitoring packets received from the remote device for an indication the receive link on the remote device has been trained comprises examining the value of a status bit in the packets received from the remote device.

4. The method of claim 1, wherein providing an indication of whether the local device receive link components have been successfully trained in packets transmitted from the local device to the remote device comprises setting or clearing a status bit in the transmitted packets.

5. The method of claim 1, further comprising, during transmit link training, periodically transmitting control packets for use in calculating a checksum at the remote device.

6. The method of claim 0, further comprising:
monitoring the receive link for control packets received from the remote device; and
repeating the receive link training if a control packet is not received in a predetermined timeout period.

7. The method of claim 6, wherein the predetermined timeout period is determined by an adjustable register.

8. The method of claim 0, further comprising:
maintaining a history of comparisons of checksums calculated for packets received from the remote device, after successful receive link training; and
repeating the receive link training if a history indicates a plurality of successive failed checksum comparisons.

9. A method of training two devices for communication over a link without software interaction, comprising:
performing hardware controlled transmit link training in each device, wherein synchronization packets are transmitted to the other device;
performing initial hardware controlled receive link training in each device to compensate for skew between bits of data transmitted over the link and achieve synchronization with the other device based on synchronization packets received from the other device; and
performing hardware controlled handshaking between the devices to indicate successful link training, wherein the hardware controlled handshaking comprises, for each device, providing an indication in a control packet sent to the other device that the device sending the control packet has achieved synchronization.

10. The method of claim 9, further comprising:
continuously monitoring, by each device, control packets received from the other device for an indication the other device has lost synchronization; and
in response to determining the other device has lost synchronization, repeating the hardware controlled transmit link training.

11. The method of claim 9, wherein performing initial hardware controlled link training in each device comprises, by each device, sending control packets interspersed with a stream of synchronization packets to the other device, whereby the control packets include checksums calculated at the transmitting device for comparison against checksums calculated at the receiving device.

12. A self-initializing bus interface for use in communicating between a first device containing the bus interface and a second device over a communications link, comprising:
a receive state machine to manage receive link training, wherein the receive state machine is configured to maintain a history of comparisons of checksums calculated for packets received from the second device and provide, in control packets transmitted to the second device, an indication receive link training is successful if a predetermined number of successive successful checksum comparisons is observed; and
a transmit state machine to manage transmit link training, wherein the transmit state machine is configured to transmit a stream of synchronization packets to the second device with control packets containing checksums interspersed with the synchronization packets for use in performing checksum comparisons by the second device.

13. The self-initializing bus interface of claim 12, wherein a receive component of the bus interface is configured to generate a first control signal indicative of whether the predetermined number of successful successive checksum comparisons is observed.

14. The self-initializing bus interface of claim 13, wherein a transmit component of the bus interface is configured to set a bit in control packets transmitted to the second device to indicate the status of the first control signal.

15. The self-initializing bus interface of claim 15, wherein:
the receive component is configured to generate a second control signal indicative of whether a predetermined number of failed successive checksum comparisons is observed; and
the receive state machine is configured to repeat receive link training operations in response to detecting the generated second control signal.

16. The self-initializing bus interface of claim 12, wherein:
a receive component of the bus interface is configured to generate a timeout control signal if a predetermined period of time elapses without receiving a control packet from the second device; and
the receive state machine is configured to repeat receive link training in response to the timeout control signal.

17. The self-initializing bus interface of claim 12, further comprising:
an elastic buffer for holding data received from the second device and data to be transferred to the second device; and
an elastic buffer reset state machine configured to generate a debounced reset signal in response to detecting an elastic buffer reset signal generated by the elastic buffer that has not changed states for a predetermined debounce period, wherein each of the receive and transmit state machines are configured to transition to a disabled state in response to the debounced reset signal transition to a state indicative of a reset condition.

18. The self-initializing bus interface of claim 17, wherein the elastic buffer is configured to generate the elastic buffer reset signal in response to detecting a clock signal driven by the second device.

19. A system, comprising:
a bus having a plurality of parallel bit lines;
a first processing device;
a second processing device coupled with the first processing device via the bus; and
a self-initializing bus interface on each of the first and second processing devices, the bus interface in each device configured to perform, without software interaction, transmit link training wherein synchronization packets are transmitted to the other device, receive link training to compensate for skew between bits of data transmitted over the link and achieve synchronization with the other device based on synchronization packets received from the other device, and handshaking between the devices to indicate successful link training by providing an indication in a control packet sent to the other device that the device sending the control packet has achieved synchronization.

20. The system of claim 19, wherein the bus interface on each device is configured to transmit control packets containing checksums interspersed with the synchronization packets during transmit link training.

21. The system of claim 19, wherein the handshaking performed by the bus interface of each device comprises:
indicating the device is trained by trained by setting a bit in a transmitted control packet.

22. The system of claim 19, wherein the bus interface of each device is further configured to repeat receive link training if a control packet from the other device is not received within a predetermined time period.

23. The system of claim 19, wherein the first processing device is a central processing unit (CPU) and the second processing device is a graphics processing unit (GPU).
